(19) United States
(12) Patent Application Publication
(10) Pub. No.: US 2022/0188799 A1
(43) Pub. Date: Jun. 16, 2022

(54) NAVIGATION SERVER, NAVIGATION PROGRAM, AND NAVIGATION SYSTEM

(71) Applicant: TOYOTA JIDOSHA KABUSHIKI KAISHA, Toyota-shi (JP)

(72) Inventors: Ayano KIMURA, Susono-shi (JP); Hikaru SHIOZAWA, Susono-shi (JP); Toshiya HASHIMOTO, Miyoshi-shi (JP); Chuya OGAWA, Susono-shi (JP); Yuta MANIWA, Susono-shi (JP)

(73) Assignee: TOYOTA JIDOSHA KABUSHIKI KAISHA, Toyota-shi (JP)

(21) Appl. No.: 17/547,307

(22) Filed: Dec. 10, 2021

(30) Foreign Application Priority Data
Dec. 15, 2020 (JP) 2020-207860

(51) Int. Cl. G06Q 20/22; G01C 21/34

(52) U.S. Cl. CPC G06Q 20/22; G01C 21/3469

(57) ABSTRACT

A navigation server includes a processor configured to derive, based on information that a user acquires luggage outside a predetermined area, a route to a destination located in the area and associated with the user and output route information related to the derived route to an in-area vehicle that is autonomously travelable and present in the area.

### CROSS-REFERENCE TO RELATED APPLICATION

This application claims priority to Japanese Patent Application No. 2020-207860 filed on Dec. 15, 2020, incorporated herein by reference in its entirety.

### BACKGROUND

### 1. Technical Field

The present disclosure relates to a navigation server, a navigation program, and a navigation system.

### 2. Description of Related Art

Japanese Unexamined Patent Application Publication No. 2018-188027 discloses a technique in which a vehicle that has received a parking instruction autonomously travels and parks in an empty parking slot in a parking lot.

### SUMMARY

It is annoying that a user needs to set a destination each time the user carries luggage to the destination located in a predetermined area and associated with the user, such as home, using a vehicle that is capable of autonomous traveling and is present in the area.

The present disclosure has been made in view of the above issue, and an object of the present disclosure is to provide a navigation server, a navigation program, and a navigation system that can reduce annoyance of setting the destination each time luggage is transported using a vehicle capable of autonomously traveling.

A navigation server according to the present disclosure includes a processor configured to derive, based on information that a user acquires luggage outside a predetermined area, a route to a destination located in the area and associated with the user and output route information related to the derived route to an in-area vehicle that is autonomously travelable and present in the area.

A navigation program according to the present disclosure causes a processor to execute derivation of, based on information that a user acquires luggage outside a predetermined area, a route to a destination located in the area and associated with the user and outputting of route information related to the derived route to an in-area vehicle that is autonomously travelable and present in the area.

A navigation system according to the present disclosure includes: a first in-area vehicle that is present in a predetermined area, includes a first processor, and is autonomously travelable; and a navigation server including a second processor configured to derive, based on information that a user acquires luggage outside the area, a route to a destination located in the area and associated with the user and output route information related to the derived route to the first in-area vehicle.

The present disclosure achieves an effect that when luggage is transported using a vehicle capable of autonomously traveling, annoyance of setting a destination each time the luggage is transported can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a navigation system according to an embodiment;

FIG. 2 is a block diagram schematically showing the configuration of the navigation system according to the embodiment;

FIG. 3 is a diagram showing a case where a user who has a house in an area acquires luggage outside the area;

FIG. 4 is a diagram showing a control routine implemented by a navigation system according to the embodiment;

FIG. 5 is a diagram showing a case where the user hands over luggage to an in-area vehicle standing by at a waiting place in the area; FIG. 6 is a diagram showing a case where the in-area vehicle is moved from the waiting place in the area to the house of the user;

FIG. 7 is a diagram showing a case where the in-area vehicle is moved from the waiting place in the area to the house of the user via an installation location of a non-contact power supply device; and

FIG. 8 is a diagram showing a case where a plurality of in-area vehicles having different states of charge (SOC) of a battery is present in the area.

### DETAILED DESCRIPTION OF EMBODIMENTS

Hereinafter, an embodiment of a navigation server, a navigation program, and a navigation system according to the present disclosure will be described. The present embodiment does not limit the present disclosure.

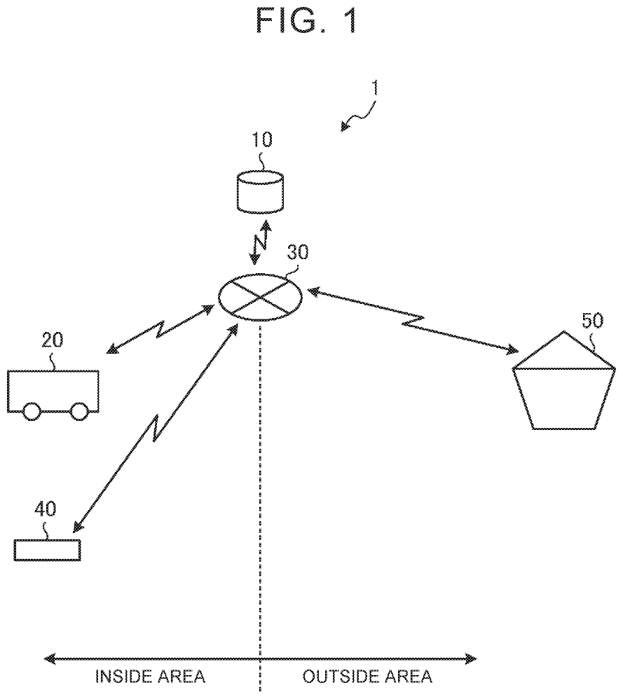

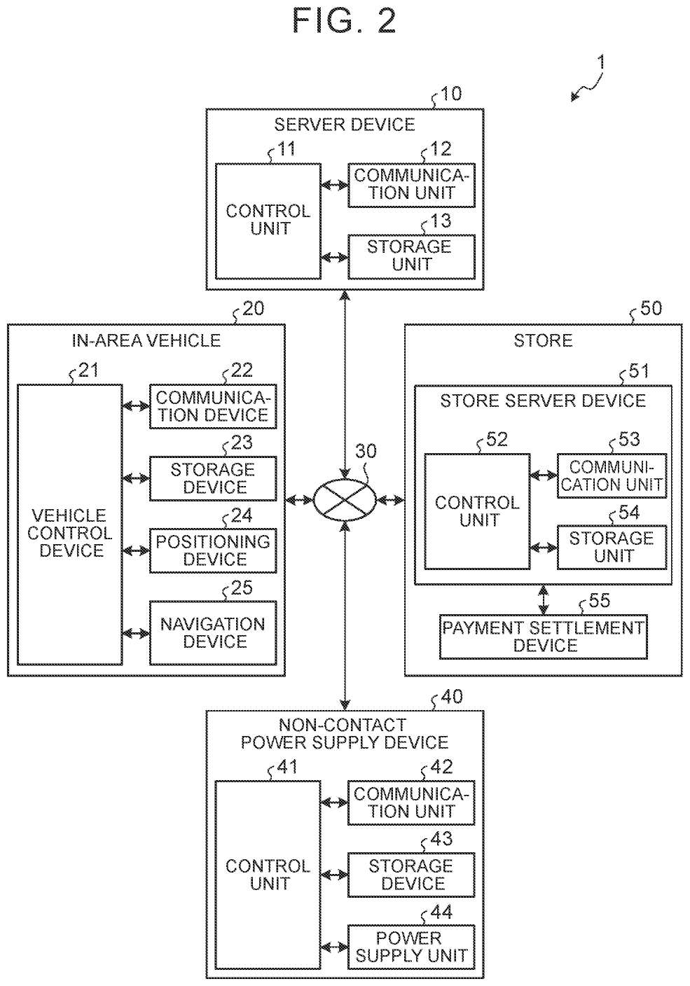

FIG. 1 is a diagram schematically showing a navigation system 1 according to an embodiment. FIG. 2 is a block diagram schematically showing the configuration of the navigation system 1 according to the embodiment.

As shown in FIG. 1, the navigation system 1 includes a server device 10, an in-area vehicle 20, a network 30, and a non-contact power supply device 40. In the present embodiment, the in-area vehicle 20 and the non-contact power supply device 40 are present in a predetermined area. Further, the server device 10 may be located inside or outside the area. In the present embodiment, for example, a predetermined area where the in-area vehicle 20 and the non-contact power supply device 40 are provided is set as a first area, and a range outside the area is within a second area that is present within a certain range outside a boundary line that separates the inside and the outside of the first area.

The server device 10, the in-area vehicle 20, and the non-contact power supply device 40 are configured to be able to communicate with each other through the network 30 that is an external communication network. The network 30 is composed of, for example, the Internet network and a mobile phone network.

The server device 10 functions as a navigation server, and includes a control unit 11, a communication unit 12, and a storage unit 13 as shown in FIG. 2.

The control unit 11 includes a processor including a central processing unit (CPU), a digital signal processor (DSP), a field-programmable gate array (FPGA), etc., and a memory (main storage unit) including a random access memory (RAM), a read-only memory (ROM), etc. The control unit 11 loads the program stored in the storage unit 13 into the work area of the main storage unit and executes the program, and controls each component, etc. through execution of the program such that the function that satisfies a predetermined purpose can be realized.

For example, the control unit 11 executes a navigation program to derive a route on which the in-area vehicle 20 travels. Further, the control unit 11 sets a power supply device search range based on the cruising range of the in-area vehicle 20, searches for the non-contact power supply device 40 included in the power supply device search range, and selects the non-contact power supply device 40 to be used for power supply.

The communication unit 12 is composed of, for example, a local area network (LAN) interface board or a wireless communication circuit for wireless communication. The communication unit 12 is connected to the network 30 such as the Internet, which is a public communication network. Then, the communication unit 12 communicates with the in-area vehicle 20 and the non-contact power supply device 40 by connecting to the network 30.

The storage unit 13 is configured of a recording medium such as an erasable programmable ROM (EPROM), a hard disk drive (HDD), and a removable media. Examples of the removable medium include disk recording media such as a universal serial bus (USB) memory, a compact disc (CD), a digital versatile disc (DVD), and a Blu-ray disc (BD; registered trademark). Further, the storage unit 13 can store an operating system (OS), various programs, various tables, various databases, and the like.

The storage unit 13 may temporarily store the calculation result or the like by the control unit 11. In addition, the storage unit 13 may store information such as the remaining battery level (state of charge: SOC) of the in-area vehicle 20 acquired by the server device 10 by communicating with the in-area vehicle 20. Further, the storage unit 13 may store power supply device information acquired by the server device 10 by communicating with the non-contact power supply device 40. The power supply device information includes, for example, the name of the non-contact power supply device 40, the position of the non-contact power supply device 40 (for example, latitude and longitude), the power supply capacity, the charging method, and the usage status of the non-contact power supply device 40.

The in-area vehicle 20 is, for example, an electric vehicle (EV) or a plug-in hybrid electric vehicle (PHEV). The in-area vehicle 20 includes a vehicle control device 21, a communication device 22, a storage device 23, a positioning device 24, and a navigation device 25. The vehicle control device 21 and the storage device 23 are physically the same as the control unit 11 and the storage unit 13 of the server device 10.

The vehicle control device 21 is an electronic control unit (ECU) that comprehensively controls operations of various components mounted on the in-area vehicle 20. The communication device 22 is composed of, for example, a data communication module (DCM) or the like, and communicates with the server device 10 by wireless communication via the network 30. Information related to the vehicle position detected by the positioning device 24 (hereinafter, referred to as “vehicle position information”) is stored in the storage device 23 as needed.

The positioning device 24 receives radio waves from a global positioning system (GPS) satellite and detects the vehicle position information. In response to this, the vehicle control device 21 periodically transmits the vehicle position information to the server device 10 through the network 30. The method of detecting the vehicle position information is not limited to the method using the GPS satellites, and for example, a method in which light detection and ranging or laser imaging detection and ranging (LiDAR) and a three-dimensional digital map are combined may be used.

The navigation device 25 inputs and outputs data such as map information and travel route information, a navigation program, and the like to and from the vehicle control device 21. As a result, the vehicle control device 21 causes the in-area vehicle 20 to autonomously travel by supplying various command signals to various components constituting the in-area vehicle 20. The navigation device 25 itself may include a control unit and a recording medium such as a CPU, RAM, and ROM.

Specifically, the navigation device 25 includes input and output means such as a touch panel display and a speaker microphone. The input and output means is configured such that predetermined information is notified externally by displaying characters, figures, etc. on the screen of the touch panel display or outputting voice from the speaker microphone in accordance with the control by the vehicle control device 21. Further, the input and output means inputs predetermined information to the vehicle control device 21 in a manner such that an occupant of the in-area vehicle 20 operates the touch panel display or utters voice toward the speaker microphone.

The navigation system 1 according to the embodiment displays a route to the installation location of the non-contact power supply device 40 searched and selected by the server device 10 on the screen of the touch panel display included in the navigation device 25, for example.

In addition to the configuration shown in FIG. 2, the in-area vehicle 20 is provided with an inverter, a motor, a battery, a loading facility of luggage, and the like. The vehicle control device 21 of the in-area vehicle 20 can detect information on SOC that is the remaining amount of the battery, and transmits the information on SOC to the server device 10 as needed.

The non-contact power supply device 40 includes a control unit 41, a communication unit 42, a storage unit 43, and a power supply unit 44. The non-contact power supply device 40 is provided in the traveling route in which the in-area vehicle 20 travels such that the in-area vehicle 20 can be located above the non-contact power supply device 40, for example.

Specifically, the control unit 41 includes a processor including a CPU, a DSP, an FPGA, or the like, and a memory including a RAM, a ROM, and the like. The control unit 41 loads the program stored in the storage unit 43 into the work area of the memory and executes the program, and the function that satisfies a predetermined purpose is realized by controlling each unit, etc., such as controlling a power supply function by the power supply unit 44 through execution of the program.

The communication unit 42 is composed of, for example, a LAN interface board and a wireless communication circuit for wireless communication. The communication unit 42 is connected to the network 30. Then, the communication unit 42 communicates with the server device 10 and the in-area vehicle 20 by connecting to the network 30.

The storage unit 43 is composed of a recording medium such as an EPROM, a hard disk drive, and a removable medium. Examples of the removable medium include the USB memory and the disc recording media such as CD, DVD, and BD. Further, the storage unit 43 can store the operating system, various programs, various tables, various databases, and the like.

The storage unit 43 may store information on the non-contact power supply device 40 (power supply device information). The information on the non-contact power supply device 40 includes the name of the non-contact power supply device 40, the position of the non-contact power supply device 40 (for example, latitude, longitude, and area), the power supply capacity, the power supply method, and the usage status of the non-contact power supply device 40.

The power supply unit 44 supplies electric power to a power receiving unit provided in the in-area vehicle 20 in a non-contact manner to charge the battery of the in-area vehicle 20.

The store 50 includes a store server device 51 and a payment settlement device 55. The store server device 51 has a control unit 52, a communication unit 53, and a storage unit 54.

The control unit 52 includes a processor including a CPU, a DSP, an FPGA, or the like, and a memory including a RAM, a ROM, and the like. The control unit 52 loads the program stored in the storage unit 54 into the work area of the memory and executes the program, and controls each unit, etc. through execution of the program such that the function that satisfies a predetermined purpose can be realized.

The communication unit 53 is composed of, for example, a LAN interface board and a wireless communication circuit for wireless communication. The communication unit 53 is connected to the network 30. Then, the communication unit 53 communicates with the server device 10 and the like by connecting to the network 30.

The storage unit 54 is composed of a recording medium such as an EPROM, a hard disk drive, and a removable medium. Examples of the removable medium include the USB memory and the disc recording media such as CD, DVD, and BD.

Further, the storage unit 54 can store an operating system, various programs, various tables, various databases, and the like.

The storage unit 54 records, for example, user information related to a user who uses a wallet as a virtual deposit and withdrawal account of electronic money, wallet information related to the wallet, and payment settlement information related to payment settlement of the wallet. Examples of the user information include, for example, a user ID, a password, a user name, user contact information (for example, an address, a telephone number, and an e-mail address) of the user who has registered for use of the wallet, device information related to a mobile terminal of the user (device address, Internet protocol (IP) address, etc.), usage registration history, and information on payment means registered as deposit means, information indicating a plurality of payment means (name of the payment settlement application) registered as payment settlement means for the mobile terminal, and a password for making a payment settlement. Further, examples of the wallet information include, for example, the user ID (recipient identification information, payer identification information), an account corresponding to the payment settlement means specified by the user ID (recipient identification information, payer identification information), a balance of the electronic money, a deposit history of the electronic money, and a usage history of the electronic money. Further, the payment settlement information includes the user ID, the payment settlement means used for performing the payment settlement (e.g. electronic money payment (non-contact payment), scan payment, or code payment), and a payment settlement history.

The “payment settlement means” refers to means of performing payment settlement using the payment means. The payment settlement means includes electronic money payment, scan payment and code payment. The electronic money payment is, for example, payment settlement performed in a non-contact manner by short-range wireless communication between the mobile terminal of the user and the payment settlement device 55 as the user holds the mobile terminal of the user over the payment settlement device 55 of the store 50. Further, the scan payment is payment settlement performed by reading a barcode or a Quick Response (QR) code (registered trademark) displayed on the payment settlement device 55 or the like with a camera or the like provided for the mobile terminal of the user. Further, the code payment is payment settlement performed by reading a barcode or QR code (registered trademark) displayed on the mobile terminal of the user with the code reader of the payment settlement device 55 or the like.

The payment settlement device 55 includes a processor including a CPU,

DSP, FPGA, and or like, and a memory including RAM, ROM, and the like. The payment settlement device 55 makes a payment using, for example, payment means such as electronic money payment, scan payment, and code payment using the mobile terminal of the user.

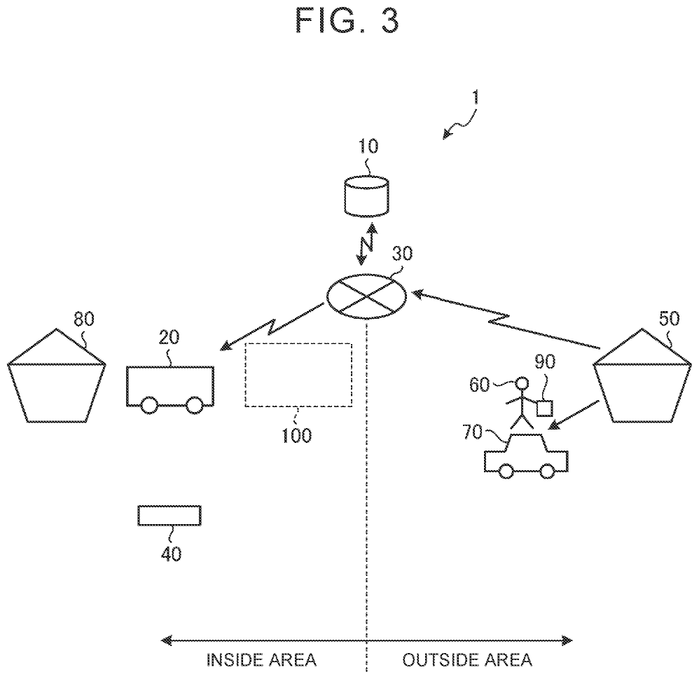

FIG. 3 is a diagram showing a case where a user 60 having a house 80 in the area acquires luggage 90 outside the area. In FIG. 3, a private vehicle 70 owned by the user 60 having the house 80 in the area is prohibited from traveling in the area, and the private vehicle 70 cannot enter the house 80 in the area from outside the area. Therefore, it is difficult for the user 60 to drive the private vehicle 70 to the store 50 outside the area and carry the luggage 90 purchased at the store 50 to the house 80 in the area. Therefore, in the present embodiment, the luggage 90 is handed over to the in-area vehicle 20, and the in-area vehicle 20 is caused to autonomously travel and transport the luggage 90 to the house 80 of the user 60. At this time, when it is necessary to set the house 80 of the user 60 as the destination each time the luggage 90 is transported, annoyance occurs. Therefore, in the navigation system 1 according to the present embodiment, the server device 10 derives a route to the house 80 that is the destination located in the area and associated with the user 60, based on information that the user 60 has acquired the luggage 90 outside the area, and outputs information related to the derived route to the in-area vehicle 20. Then, after the luggage 90 is handed over by the user 60 to the in-area vehicle 20 in the area, the in-area vehicle 20 autonomously travels based on the information related to the route acquired from the server device 10, and transports the luggage 90 to the house 80 of the user 60.

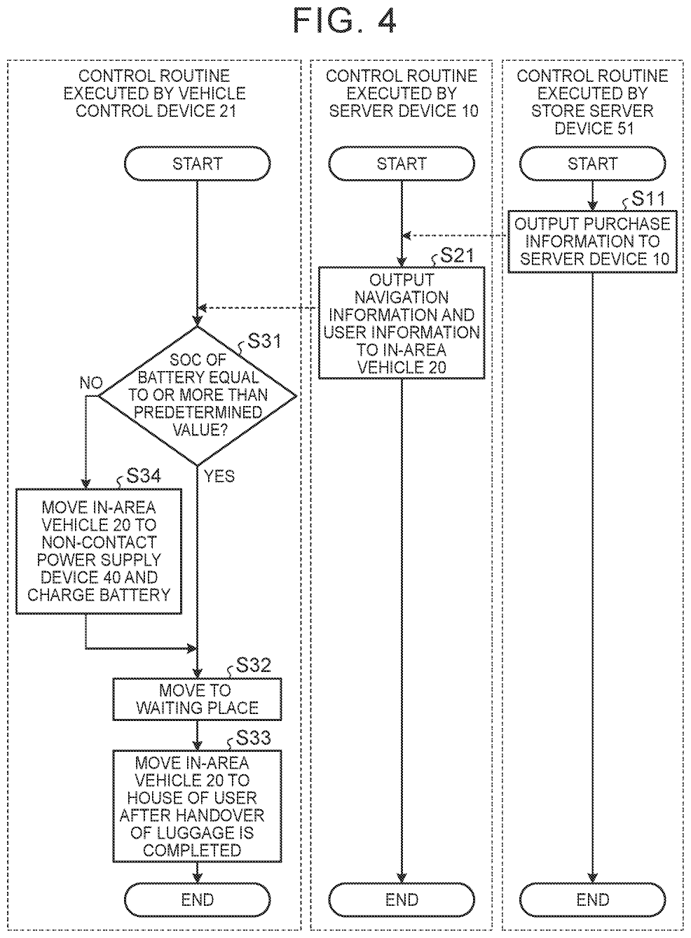

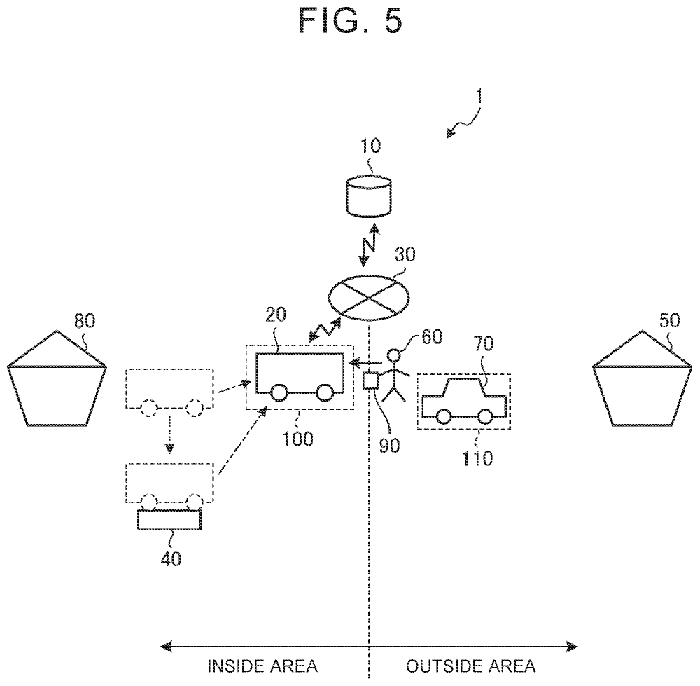

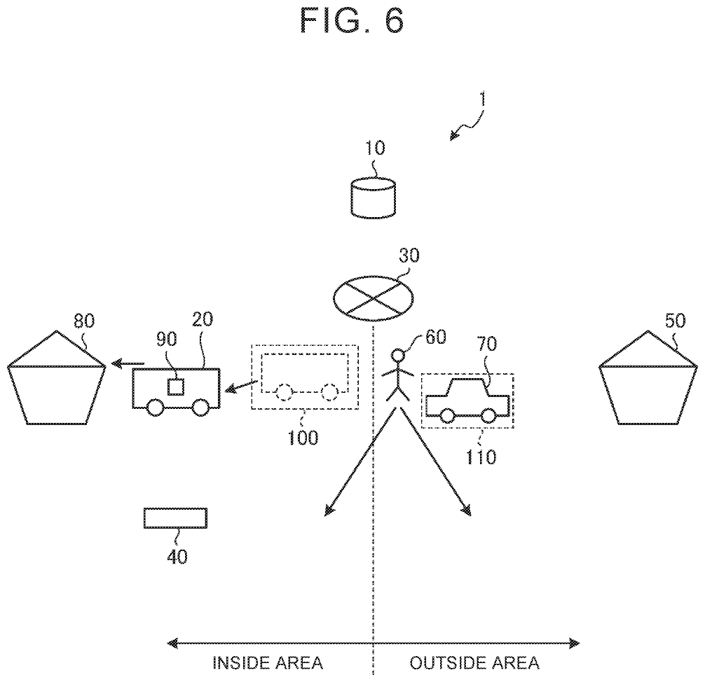

FIG. 4 is a diagram showing a control routine implemented by the navigation system 1 according to the embodiment. The control routine shown in FIG. 4 is composed of a control routine executed by the server device 10, a control routine executed by the vehicle control device 21 of the in-area vehicle 20, and a control routine executed by the store server device 51 of the store 50. The control routine shown in FIG. 4 is executed in collaboration with the server device 10, the vehicle control device 21, and the store server device 51.

First, in step S11, the store server device 51 outputs purchase information of the product as information that the user 60 has acquired the luggage 90 outside the area, the user information including the address of the user 60, etc., to the server device 10 via the network 30 based on the payment settlement information by the payment settlement device 55. Then, the store server device 51 ends the present control routine.

Next, in step S21, the server device 10 derives a route to the house 80 that is the destination located in the area and associated with the user 60 based on the purchase information and the user information. The server device 10 then outputs the navigation information and the user information that are the route information related to the derived route to the in-area vehicle 20 that is capable of autonomously traveling and is present in the area. In the present embodiment, as the derived route, the server device 10 derives a route in which the in-area vehicle 20 travels to the house 80 via a waiting place 100 that is provided in the area for temporarily causing the in-area vehicle 20 to stand by. Further, in the present embodiment, as the derived route, the server device 10 derives a route in which the in-area vehicle 20 travels to an installation location where the non-contact power supply device 40 that supplies electric power to the battery is installed before reaching the waiting place 100 when the SOC that is the remaining amount of the battery of the in-area vehicle 20 is less than a predetermined value. Then, the server device 10 ends the present control routine.

The installation location of the power supply device through which the in-area vehicle 20 travels when the SOC of the battery of the in-area vehicle 20 is less than the predetermined value is not limited to the installation location of the non-contact power supply device 40. For example, the installation location may be an installation location of a direct-current (DC) power supply device or an alternate-current (AC) power supply device of which power supply cable is connected to the in-area vehicle 20 and that transmits DC power or AC power via the power supply cable to supply power. Further, in this case, an operator at the installation location of the DC power supply device or the AC power supply device connects the power supply cable to the in-area vehicle 20 to supply power. As a method of supplying power to the in-area vehicle 20 using any of the non-contact power supply device 40, the DC power supply device, and the AC power supply device, for example, a known method can be applied.

Next, in step S31, the vehicle control device 21 determines whether the SOC of the battery of the in-area vehicle 20 is equal to or higher than the predetermined value. When the vehicle control device 21 determines that the SOC of the battery is equal to or higher than the predetermined value (Yes in step S31), in step S32, the vehicle control device 21 causes the in-area vehicle 20 to autonomously travel to move to the waiting place 100 provided in the area based on the navigation information. As a result, the user 60 gets on the private vehicle 70 in which the luggage 90 is loaded and moves to a parking space 110 provided outside the area and adjacent to the waiting place 100, whereby the user 60 can hand over the luggage 90 to the in-area vehicle 20 that stands by at the waiting place 100. Next, when the user 60 completes handover of the luggage 90 to the in-area vehicle 20 in step S33, the vehicle control device 21 causes the in-area vehicle 20 to autonomously travel to move to the house 80 of the user 60 provided in the area based on the navigation information. When handover of the luggage 90 to the in-area vehicle 20 is completed, for example, the user 60 operates the touch panel display of the navigation device 25 provided in the in-area vehicle 20, the mobile terminal of the user 60, or the like so as to output, to the vehicle control device 21, handover completion information (receipt completion information) of the luggage 90 by the user 60 corresponding to the user information. Then, the vehicle control device 21 ends the control routine.

On the other hand, when the vehicle control device 21 determines that the SOC of the battery of the in-area vehicle 20 is less than the predetermined value (No in step S31), in step S34, the vehicle control device 21 causes the in-area vehicle 20 to autonomously travel to move to the installation location of the non-contact power supply device 40 provided in the area based on the navigation information to charge the battery. Next, when charging of the battery is completed, in step S32, the vehicle control device 21 causes the in-area vehicle 20 to autonomously travel to the waiting place 100 provided in the area based on the navigation information. Next, when the user 60 completes handover of the luggage 90 to the in-area vehicle 20 in step S33, the vehicle control device 21 causes the in-area vehicle 20 to autonomously travel to move to the house 80 of the user 60 provided in the area based on the navigation information. Then, the vehicle control device 21 ends the control routine.

As described above, in the present embodiment, the server device 10 derives the route in which the in-area vehicle 20 travels to the house 80 that is the destination located in the area and associated with the user 60, based on the information (purchase information) that the user 60 has acquired the luggage 90 outside the area, and outputs the information related to the derived route (navigation information) to the in-area vehicle 20. As a result, when the in-area vehicle 20 is caused to autonomously travel to transport the luggage 90 to the house 80, annoyance caused by the need for setting the destination by the user 60 each time the luggage 90 is transported can be suppressed. Further, in the present embodiment, the luggage 90 of the user 60 acquired outside the area is handed over to the in-area vehicle 20 that is made to stand by at the waiting place 100 provided for the in-area vehicle 20, and the in-area vehicle 20 is caused to autonomously travel to transport the luggage 90 to the house 80 of the user 60. As a result, even when the private vehicle 70 of the user 60 cannot enter the area from outside the area, the user 60 can return to the house 80 in the area or move from the waiting place 100 to another location outside the area empty-handed after the user 60 hands over the luggage 90 to the in-area vehicle 20 at the waiting place 100. Further, when the SOC of the battery of the in-area vehicle 20 is less than the predetermined value, the in-area vehicle 20 heads to the waiting place 100 after the battery is charged with the non-contact power supply device 40. Therefore, it is possible to suppress the in-area vehicle 20 from being unable to travel due to battery shortage of the in-area vehicle 20 on the way to the waiting place 100 or on the way from the waiting place 100 to the house 80 of the user 60.

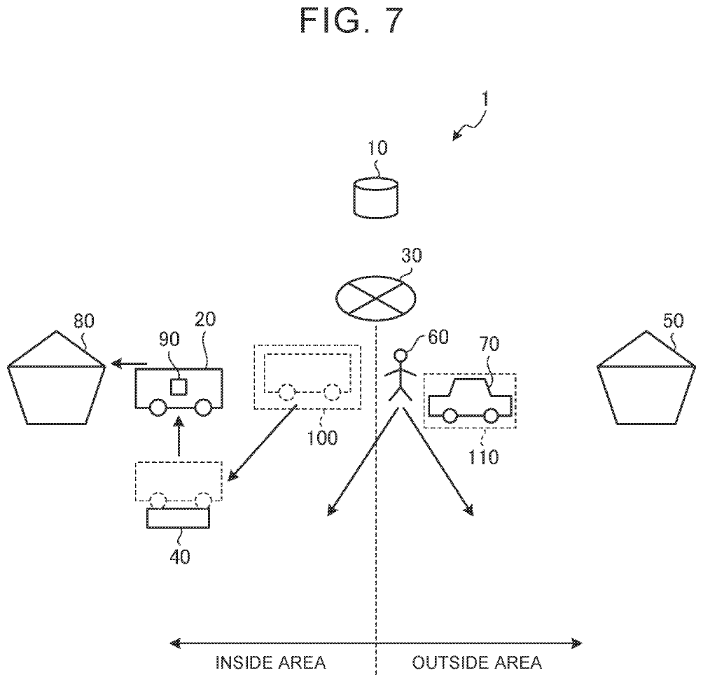

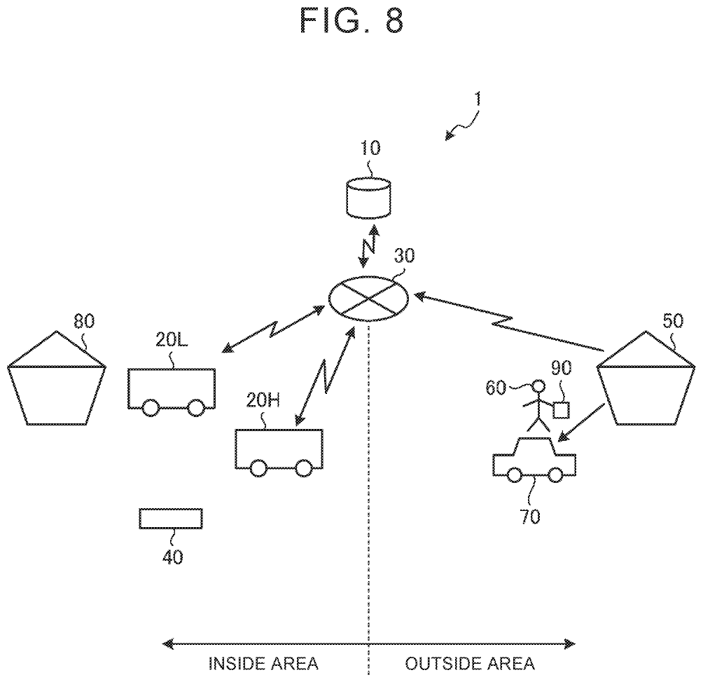

As shown in FIG. 7, when the vehicle control device 21 causes the in-area vehicle 20 to move from the waiting place 100 in the area to the house 80 of the user 60, the vehicle control device 21 may cause the in-area vehicle 20 to travel to the house 80 of the user 60 via the installation location of the non-contact power supply device 40 so as to charge the battery, depending on the SOC of the battery of the in-area vehicle 20. Further, as shown in FIG. 8, when an in-area vehicle 20H in which the SOC of the battery is large (the remaining amount of the battery is large) and an in-area vehicle 20L in which the SOC of the battery is smaller (the remaining amount of the battery is smaller) than that of the vehicle 20H are both present in the area, the server device 10 may output the navigation information and the user information to the in-area vehicle 20H having the larger SOC of the battery and cause the in-area vehicle 20H to transport the luggage 90.

Further, the server device 10 may select a vehicle equipped with a heat insulating device that keeps the temperature of the luggage 90 constant as the in-area vehicle 20, output the navigation information and the user information to the selected in-area vehicle 20, and cause the in-area vehicle 20 to transport the luggage 90.

Further, when the vehicle control device 21 of the in-area vehicle 20 does not acquire the navigation information from the server device 10, the vehicle control device 21 may cause the in-area vehicle 20 to stand by at the waiting place 100 that is provided in the area and where the in-area vehicle 20 is temporarily made to stand by.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. A navigation server, comprising a processor configured to derive, based on information that a user acquires luggage outside a predetermined area, a route to a destination located in the area and associated with the user and output route information related to the derived route to an in-area vehicle that is autonomously travelable and present in the area.

2. The navigation server according to claim 1, wherein the processor derives a route in which the in-area vehicle travels to the destination via a waiting place that is provided in the area and where the in-area vehicle is temporarily made to stand by as the route.

3. The navigation server according to claim 1, wherein the processor derives a route in which the in-area vehicle travels via an installation location where a power supply device that supplies electric power to a battery of the in-area vehicle is installed when a remaining amount of the battery is less than a predetermined value.

4. The navigation server according to claim 1, wherein the processor outputs, of a first in-area vehicle and a second in-area vehicle having a smaller remaining amount of the battery than the first in-area vehicle, the route information to the first in-area vehicle.

5. The navigation server according to claim 1, wherein the processor uses, as the information that the user acquires the luggage, payment settlement information by payment settlement means implemented when the user acquires the luggage.

6. The navigation server according to claim 5, wherein:
the payment settlement information includes user information including an address of the user; and
the processor sets the address of the user as the destination.

7. A navigation program that causes a processor to execute derivation of, based on information that a user acquires luggage outside a predetermined area, a route to a destination located in the area and associated with the user and outputting of route information related to the derived route to an in-area vehicle that is autonomously travelable and present in the area.

8. The navigation program according to claim 7, wherein the processor is made to execute derivation of a route in which the in-area vehicle travels to the destination via a waiting place that is provided in the area and where the in-area vehicle is temporarily made to stand by as the route.

9. The navigation program according to claim 7, wherein the processor is made to execute derivation of a route in which the in-area vehicle travels via an installation location where a power supply device that supplies electric power to a battery of the in-area vehicle is installed when a remaining amount of the battery is less than a predetermined value.

10. The navigation program according to claim 7, wherein the processor is made to execute outputting of, of a first in-area vehicle and a second in-area vehicle having a smaller remaining amount of the battery than the first in-area vehicle, the route information to the first in-area vehicle.

11. The navigation program according to claim 7, wherein the processor is made to execute use of, as the information that the user acquires the luggage, payment settlement information by payment settlement means implemented when the user acquires the luggage.

12. The navigation program according to claim 11, wherein:
the payment settlement information includes user information including an address of the user; and
the processor is made to perform setting of the address of the user as the destination.

13. A navigation system, comprising:
a first in-area vehicle that is present in a predetermined area, includes a first processor, and is autonomously travelable; and
a navigation server including a second processor configured to derive, based on information that a user acquires luggage outside the area, a route to a destination located in the area and associated with the user and output route information related to the derived route to the first in-area vehicle.

14. The navigation system according to claim 13, wherein the second processor derives a route in which the first in-area vehicle travels to the destination via a waiting place that is provided in the area and where the first in-area vehicle is temporarily made to stand by as the route.

15. The navigation system according to claim 13, wherein the second processor derives a route in which the first in-area vehicle travels via an installation location where a power supply device that supplies electric power to a battery of the first in-area vehicle is installed when a remaining amount of the battery is less than a predetermined value.

16. The navigation system according to claim 15, wherein the power supply device is a non-contact power supply device that supplies electric power to the battery in a non-contact manner.

17. The navigation system according to claim 13, wherein the first processor causes the first in-area vehicle to stand by at a waiting place that is provided in the area and where the first in-area vehicle is temporarily made to stand by when the route information is not acquired from the navigation server.

18. The navigation system according to claim 13, wherein the second processor outputs, of the first in-area vehicle and a second in-area vehicle having a smaller remaining amount of the battery than the first in-area vehicle, the route information to the first in-area vehicle.

19. The navigation system according to claim 13, further comprising a store server device that is provided outside the area and includes a third processor, wherein the second processor uses, as the information that the user acquires the luggage, payment settlement information by payment settlement means implemented when the user acquires the luggage, the payment settlement information being output from the store server device.

20. The navigation system according to claim 19, wherein:
the payment settlement information includes user information including an address of the user; and
the second processor sets the address of the user as the destination.
